(19) United States
(12) Patent Application Publication
(10) Pub. No.: US 2008/0070079 A1
(43) Pub. Date: Mar. 20, 2008

(54) FUEL CELL SYSTEM

(76) Inventors: Steven R. Knight, Portland, CT (US); Ryan D. Cutter, Farmington, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(21) Appl. No.: 11/537,133

(22) Filed: Sep. 29, 2006

Related U.S. Application Data
(60) Provisional application No. 60/721,906, filed on Sep. 29, 2005.

(51) Int. Cl. H01M 8/04

(52) U.S. Cl. 429/26; 429/39

(57) ABSTRACT

A fuel cell system comprising a fuel cell stack and a layer assembly forming the fluid circuitry for the fuel cell stack. The layer assembly comprises a plurality of layers assembled in face-to-face contact and joined together in a fluid-tight manner. At least some of the layers integrate fluid-interacting devices and/or fluid-conveying channels. The layers have aligned openings for forming potential passageways through the layer assembly, and these passageways are partially opened and/or partially blocked to form the fluid circuitry.

### RELATED APPLICATION

This application claims priority under 35 U.S.C. §119 (e) to U.S. Provisional Patent Application No. 60/721,906 filed on Sep. 29, 2005. The entire disclosure of this provisional application is hereby incorporated by reference.

### GENERAL FIELD

This disclosure relates generally to a fuel cell system comprising a fuel cell stack and fluid circuitry forming flow paths to and from the fuel cell stack.

### BACKGROUND

A fuel cell system comprises a stack of fuel cells for generating a power output. In such a system, an anode fluid circuit forms a flow path for anode gas (e.g., a hydrogen-containing gas) through the fuel cell stack and a cathode fluid circuit forms a flow path for cathode gas (e.g., air) through the fuel cell stack. A coolant fluid circuit can form a flow path for coolant fluid (e.g., water) through the fuel cell stack. If the coolant fluid circuit includes a heat exchanger, a heat-exchanger-cooling fluid circuit can form a flow path for a cooling fluid (e.g., air) through the heat exchanger. Such fluid circuitry commonly includes fluid-interacting devices (pumps, humidifiers, filters, valves, pressure regulators, flow meters, etc.

### SUMMARY

A fuel cell system is provided wherein a layer assembly provides the fluid circuitry for conveying fluids to/from the fuel cell stack. The layer assembly has a plurality of layers assembled in face-to-face contact and joined together in a fluid-tight manner, with at least some of the layers integrating fluid-interacting devices and/or fluid-conveying channels. The layers have aligned openings forming potential passageways, and these passageways can be partially opened and/or partially blocked to form the fluid circuitry. Thus, the layer assembly can assimilate balance-of-plant (and/or other) features into the fuel cell system without complicated tubing, hosing, and/or other plumbing. These and other features are fully described and particularly pointed out in the claims. The following description and annexed drawings set forth in detail certain illustrative embodiments of the invention, these embodiments being indicative of but a few of the various ways in which the principles of the invention may be employed.

### DRAWINGS

FIG. 1 is a schematic side view of a fuel cell system, the system comprising a fuel cell stack and a layer assembly forming fluid circuitry.

FIG. 2 is a schematic top view of the fuel cell system of FIG. 1.

FIGS. 3A-3J are schematic side views of the fuel cell system of FIG. 1, the views being cut away to show fluid circuitry.

FIG. 4 is a schematic side view of another fuel cell system.

FIG. 5 is a schematic top view of the fuel cell system of FIG. 4.

FIGS. 6A-6J are schematic side views of the fuel cell system of FIG. 4, the views being cut away to show fluid circuitry.

### DETAILED DESCRIPTION

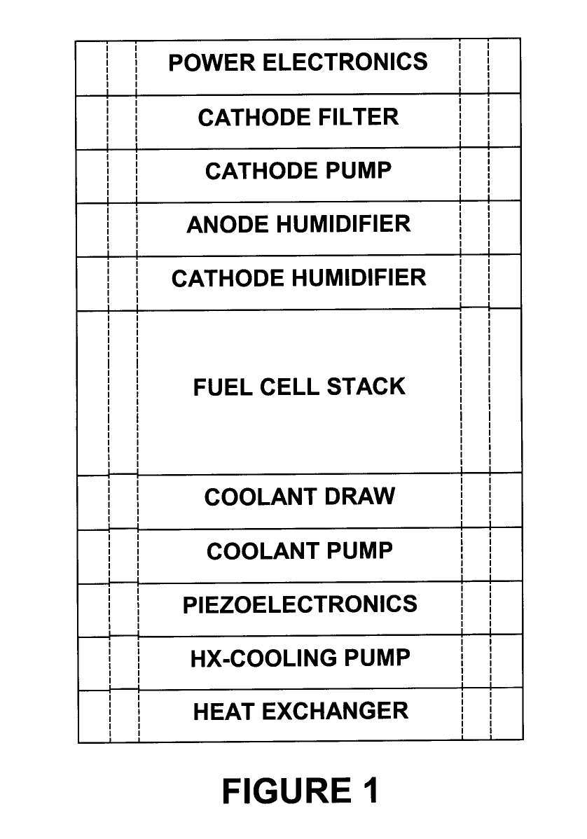

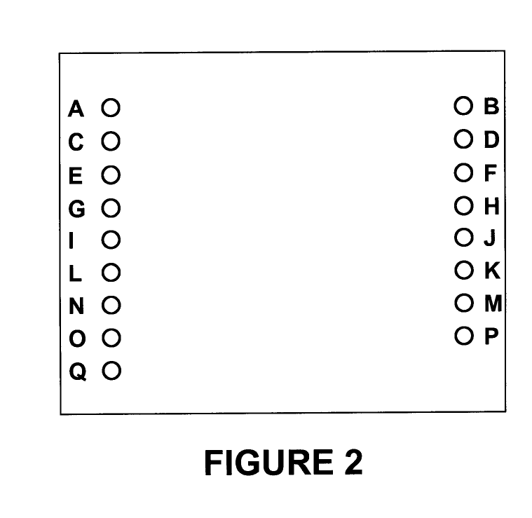

Referring now to the drawings, and initially to FIGS. 1 and 2, a fuel cell system is shown. The fuel cell system includes a fuel cell stack and a plurality of planar layers assembled in face-to-face contact and joined together in a fluid tight manner. The layers each have aligned openings forming potential passageways A-Q, which can be opened or blocked (partially or completely) to form the fluid circuitry for the fuel cell system. At least some of the layers will integrate fluid-interacting devices (pumps, humidifiers, filters, valves, pressure regulators, flow meters, etc.) and/or fluid-conveying channels.

The layers be made of any suitable material including, for example, polymer materials (e.g., plastic) and they can all be substantially the same shape/size. The openings can be formed by any suitable method (e.g., etching, milling, laser, cutting, electric discharge, machining, water jetting, stamping, etc.). The layers can be joined (usually after the formation of the openings) by any method resulting in fluid-tight seals between adjacent layers and/or around the openings in these layers. Possible joining methods include, for example, adhesive-bonding, encapsulation, and/or co-curing.

In the illustrated embodiment, the layers include a power electronics layer, a cathode filter layer, a cathode pump layer, an anode humidifier layer, and a cathode humidifier layer. The layers also include a coolant draw layer, a coolant pump layer, a piezoelectronics layer, a heat-exchanger-cooling-fluid pump layer, and a heat exchanger layer. The first group of layers are situated on one non-lateral side of the fuel cell stack and the second group of layers are situated on the opposite non-lateral side of the fuel cell stack. With particular reference to the piezoelectronics layer, it may be noted that the layered construction of the assembly lends itself nicely to incorporation with the other fluid-interacting layer.

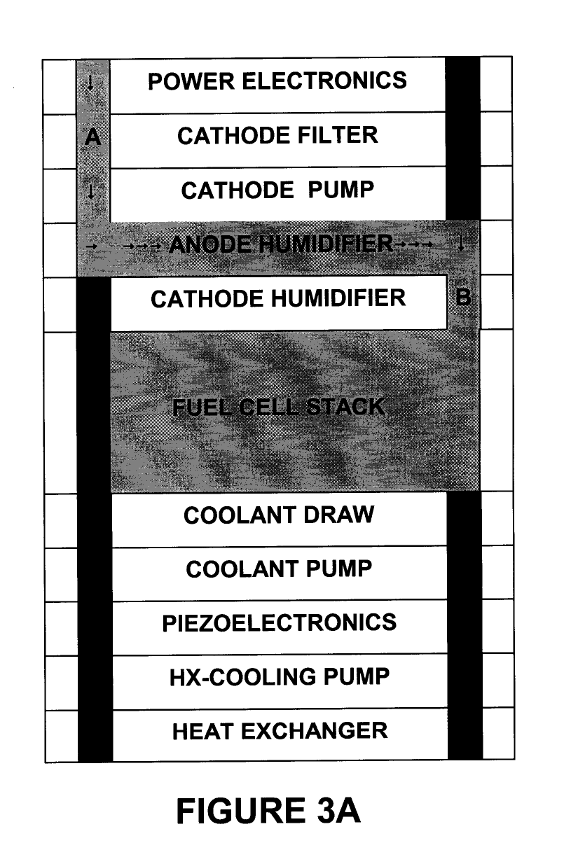

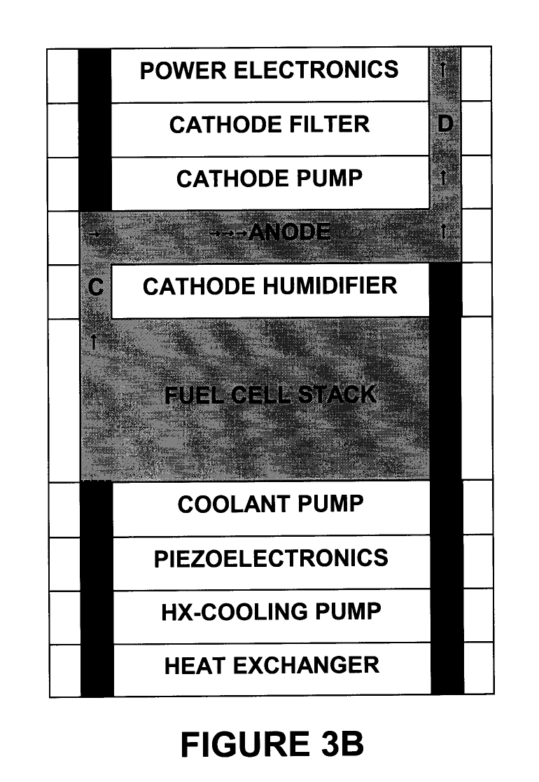

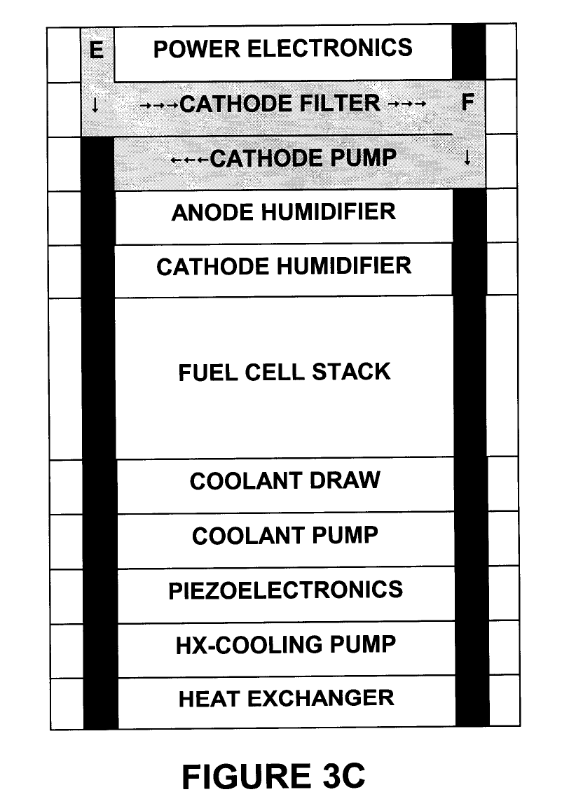

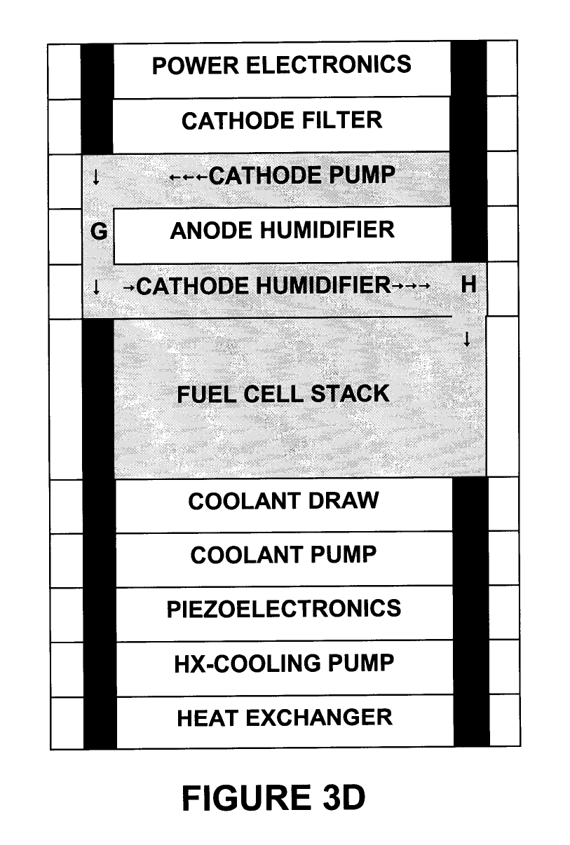

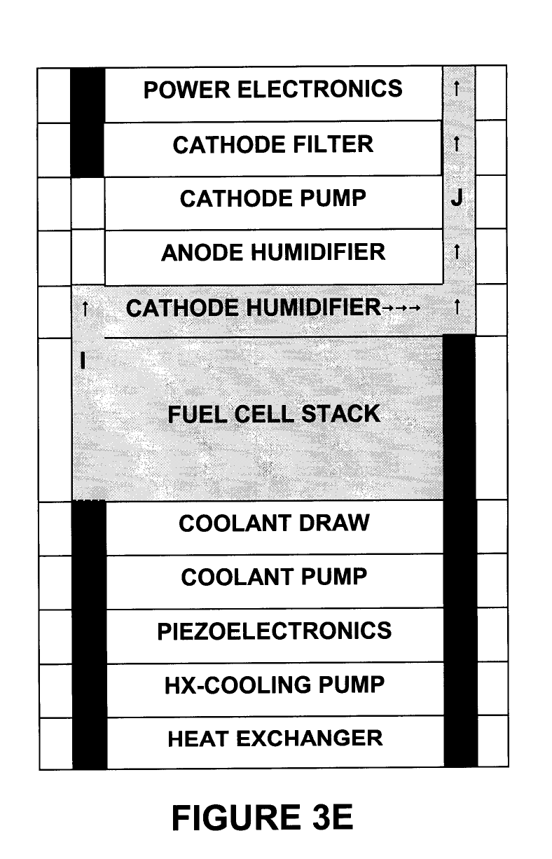

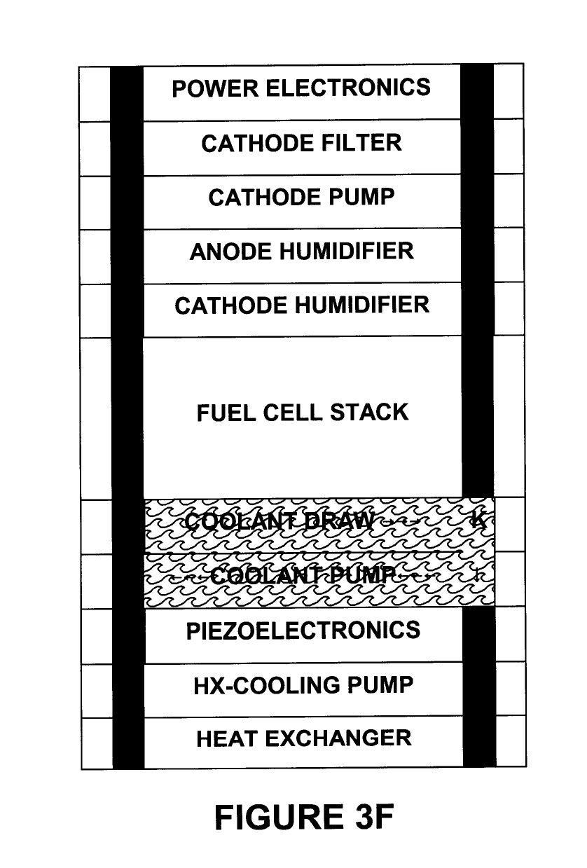

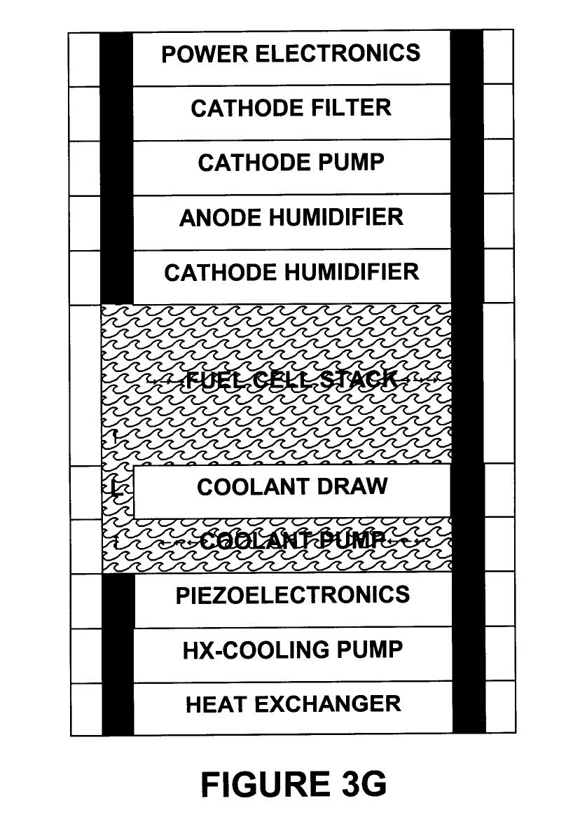

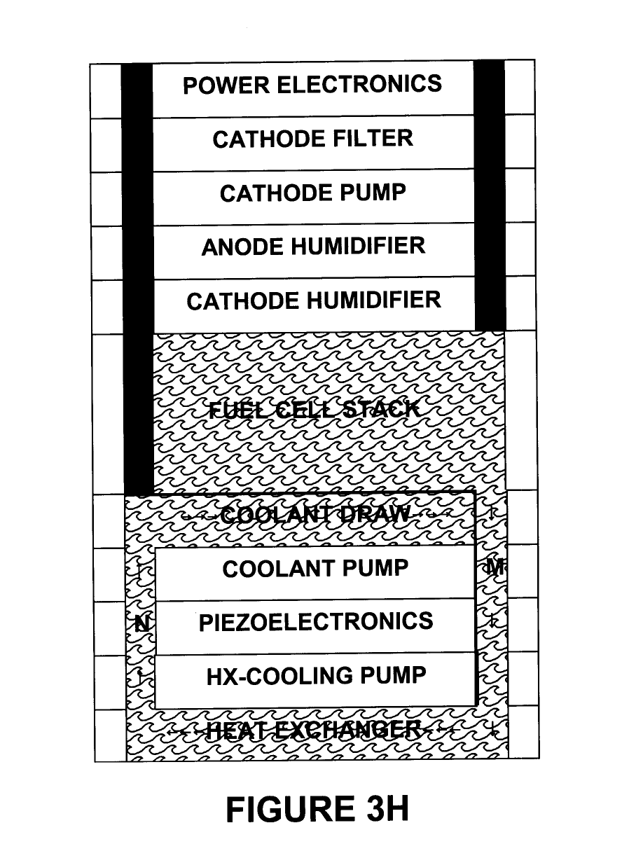

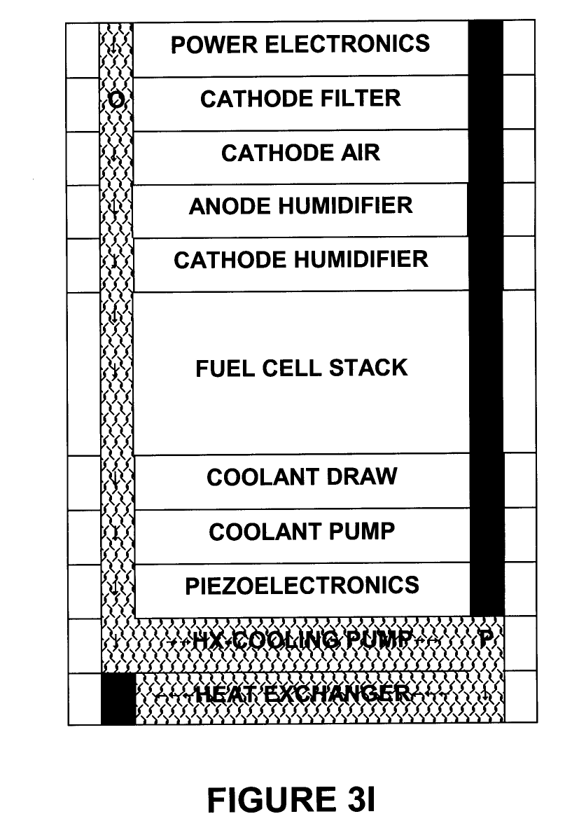

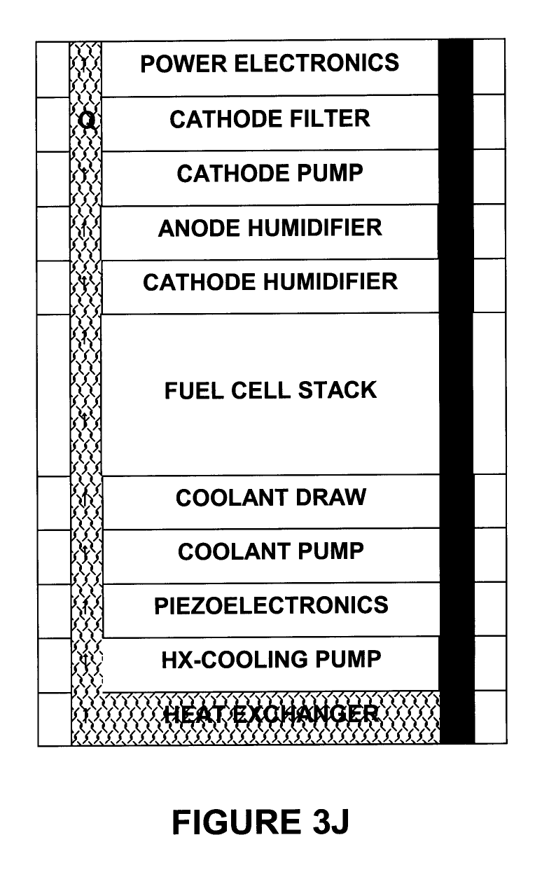

In the anode fluid circuit, the anode gas passes through passageway A, through the anode humidifier layer, through passageway B and to the fuel cell stack (FIG. 3A). The anode fluid leaves the fuel cell stack through passageway C, passes through the anode humidifier layer, and then exits through passageway D (FIG. 3B).

In the cathode fluid circuit, the cathode gas enters through passageway E, passes through the cathode filter layer, through passageway F and to the suction of the cathode pump layer (FIG. 3C). The pumped cathode gas flows through passageway G, through the cathode humidifier layer, and through passageway H to the fuel cell stack (FIG. 3D). The cathode gas leaves the fuel cell stack through passageway I, passes through the cathode humidifier layer, and exits through passageway J (FIG. 3E).

In the coolant fluid circuit, the coolant fluid passes from the coolant draw layer, via passageway K, to the suction of the coolant pump layer (FIG. 3F). The coolant fluid is pumped through passageway L to the fuel cell stack (FIG. 3G). From the fuel cell stack, the coolant fluid travels through passageway M to the heat exchanger layer, through the heat exchanger layer and then to passageway N back to the coolant draw layer, to complete the closed loop cycle (FIG. 3H). In the heat-exchanger-cooling fluid, the cooling fluid is drawn in through passageway O, pumped through the pump layer to passageway P, and then travels through the heat exchanger layer (FIG. 3I). From the heat exchanger, the cooling fluid exits through passageway Q (FIG. 3J).

In the illustrated embodiment, separate passageways were used for distinct fluid circuits. Passageways A, B, C and D were used for the anode fluid circuit, passageways E, F, G, H, I and J were used for the cathode fluid circuit, passageways K, L, M, and N were used for the coolant fluid circuit, and passageways O, P, and Q were used for the heat-exchanger-cooling fluid circuit. However, passageways can be shared by two or more non-intersecting fluid circuit sections. For example, blocked portions of passageway B (the open portions of the passageway B are part of the anode fluid circuit) (FIG. 3A) could be used instead of passageway P in the cooling fluid circuit to form the flow path between the pump and the heat exchanger (FIG. 3I).

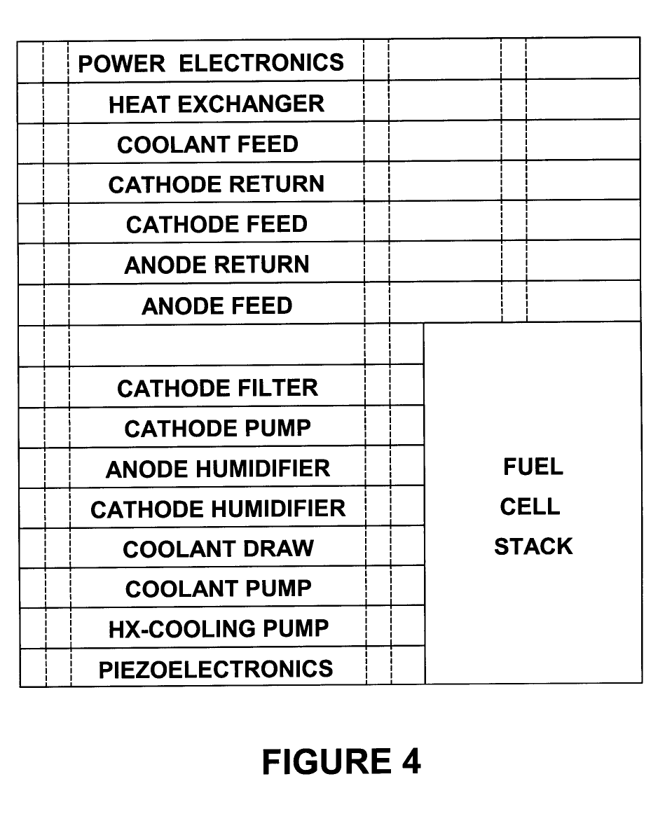

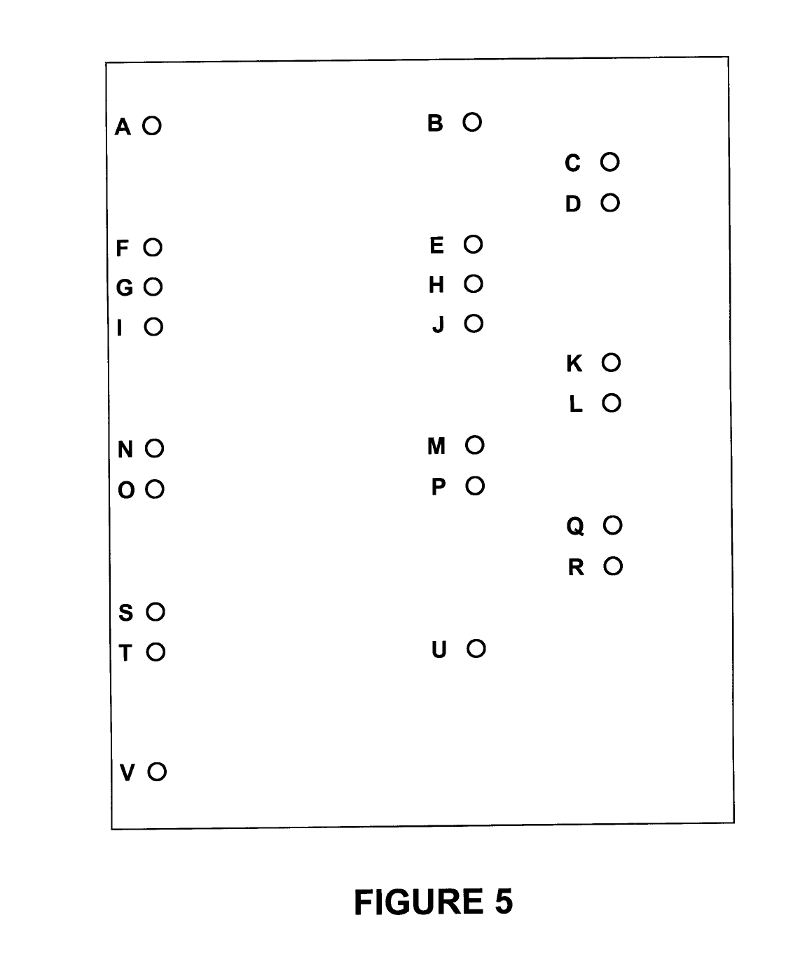

Referring now to FIGS. 4 and 5, another fuel cell system is shown, wherein a manifold is used in conjunction with the layer assembly. The layer assembly is situated on one lateral side of the fuel cell stack and the manifold is situated on one non-lateral side of the fuel cell stack. The manifold and the layer assembly together define potential passageways A-V.

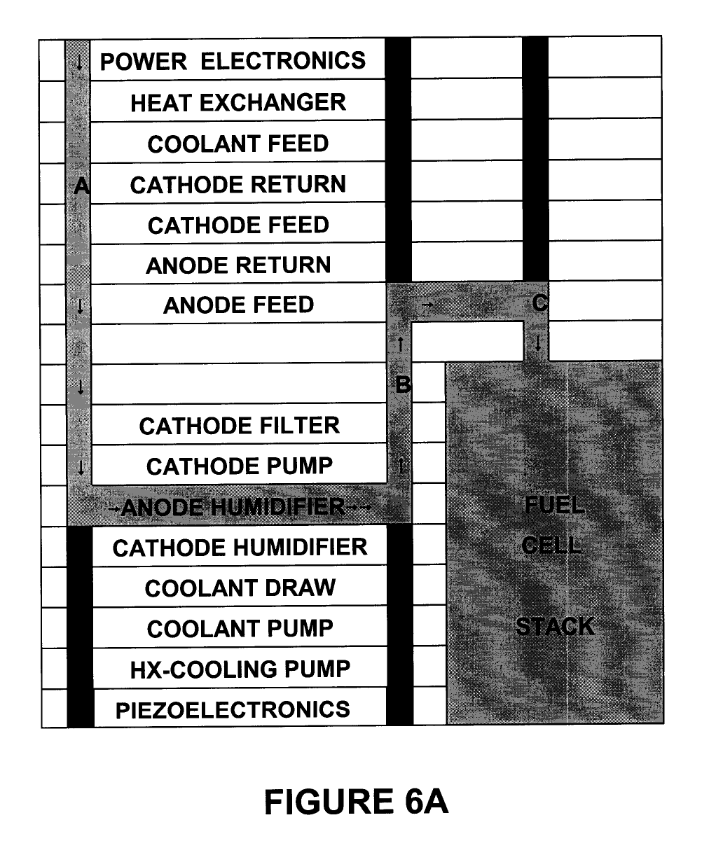

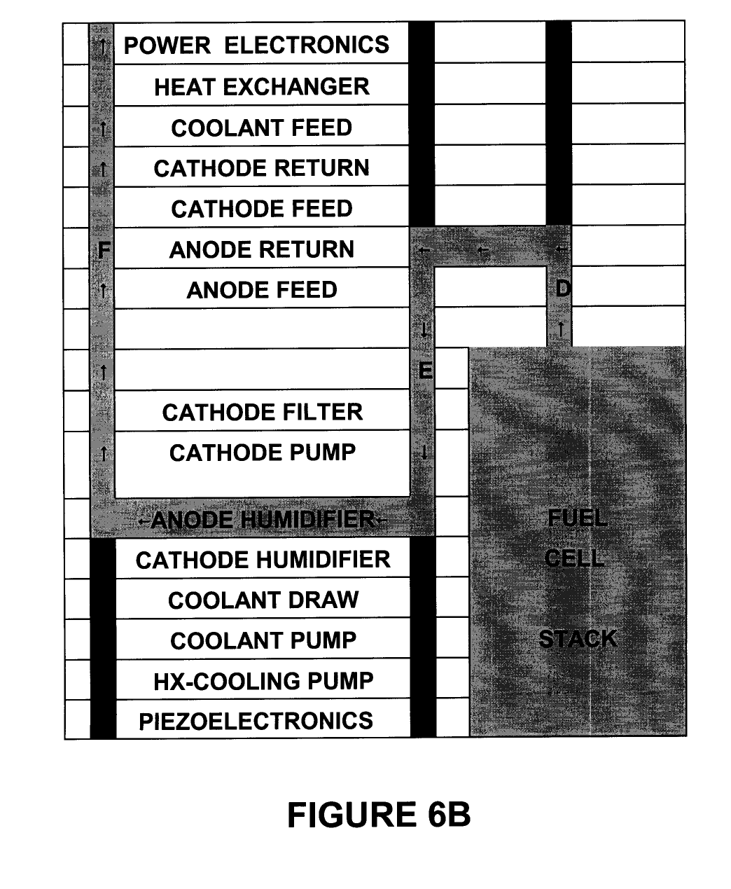

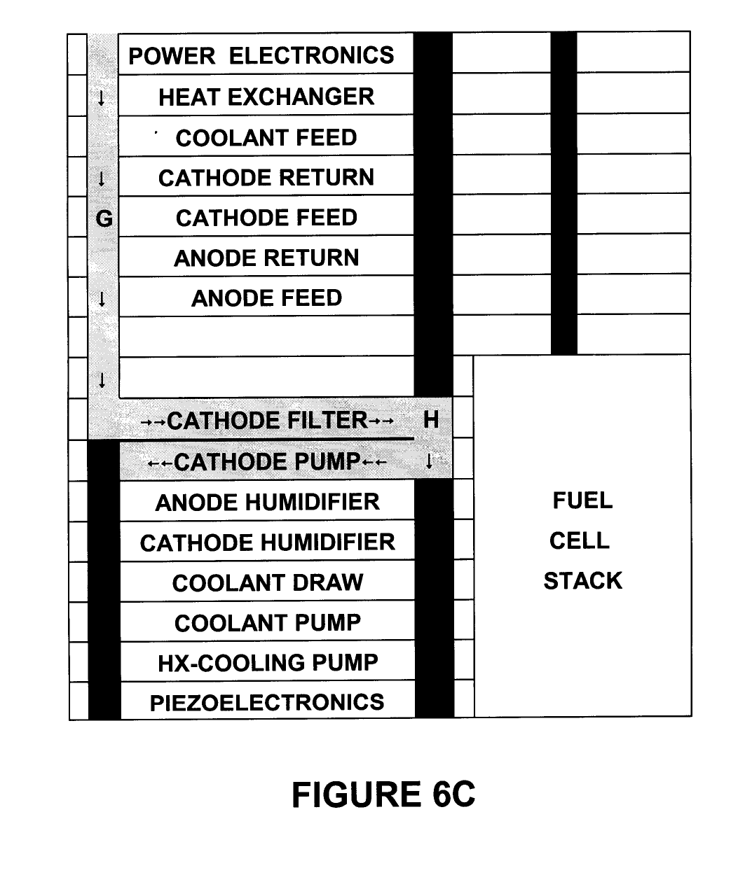

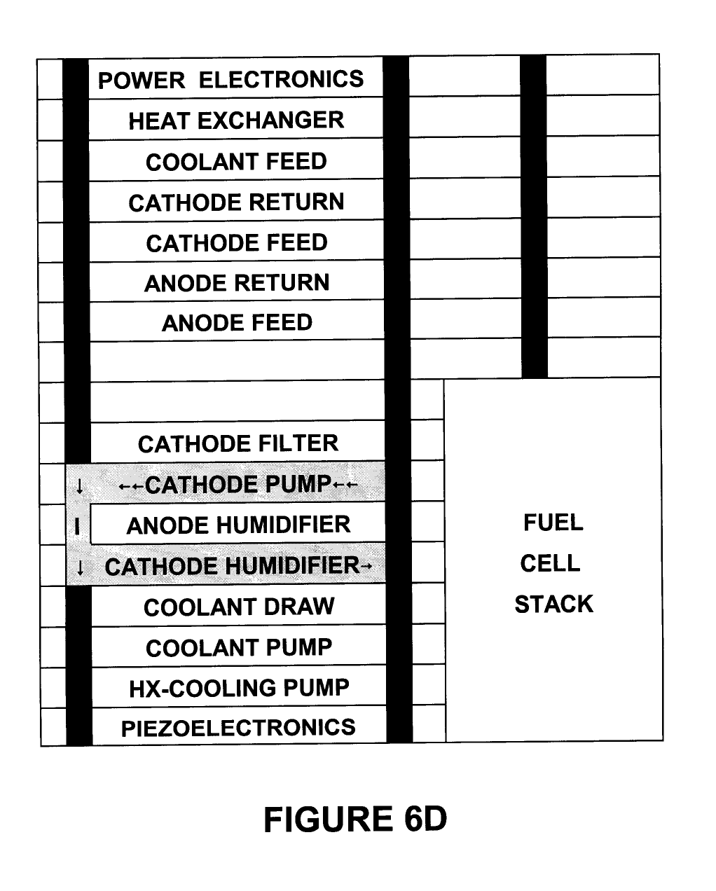

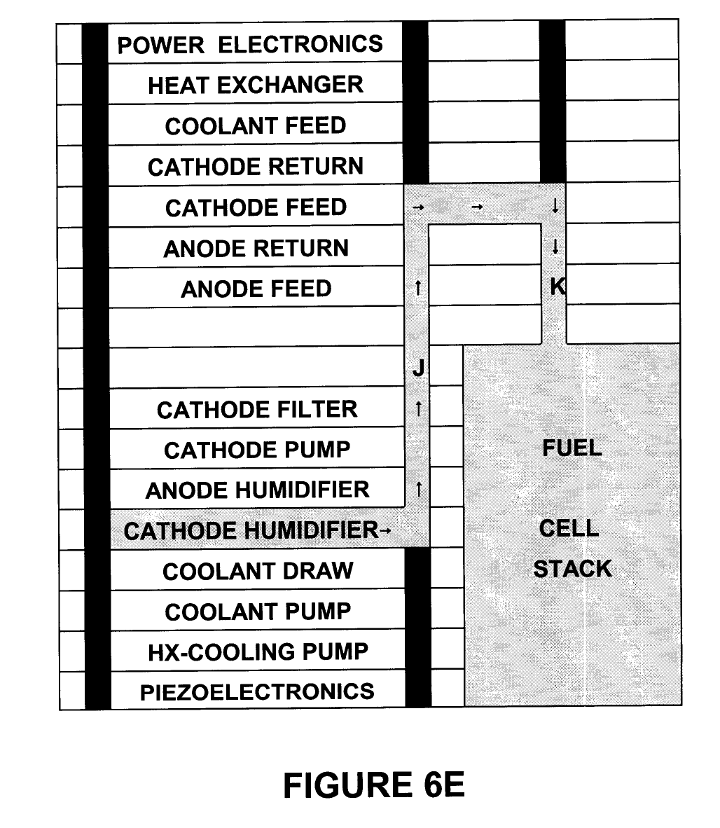

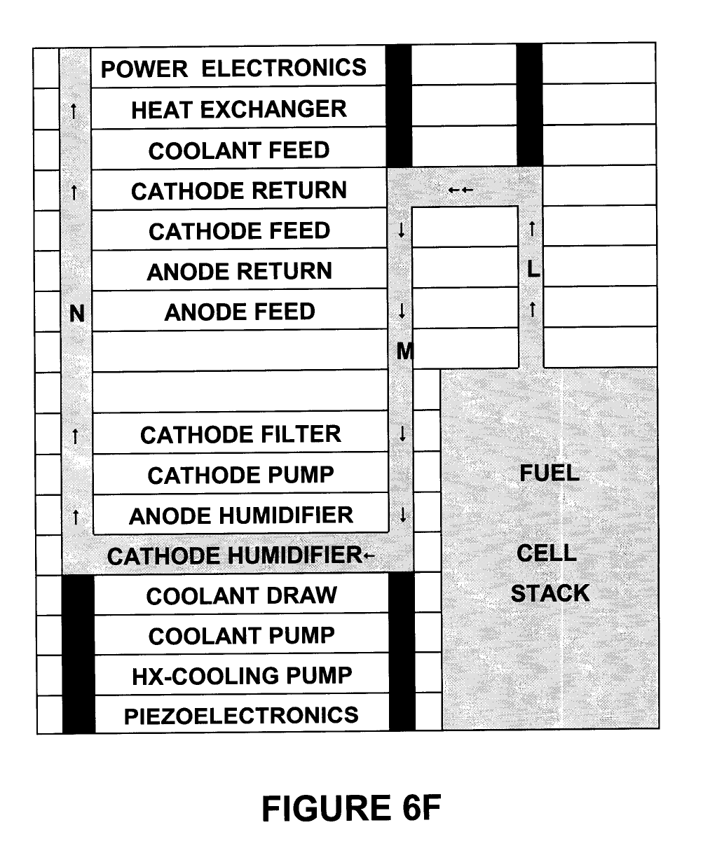

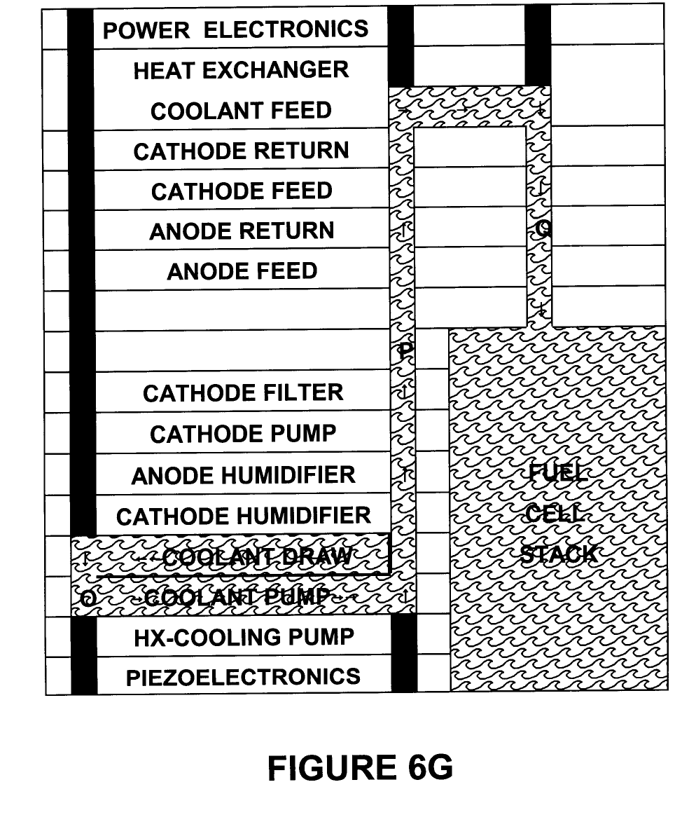

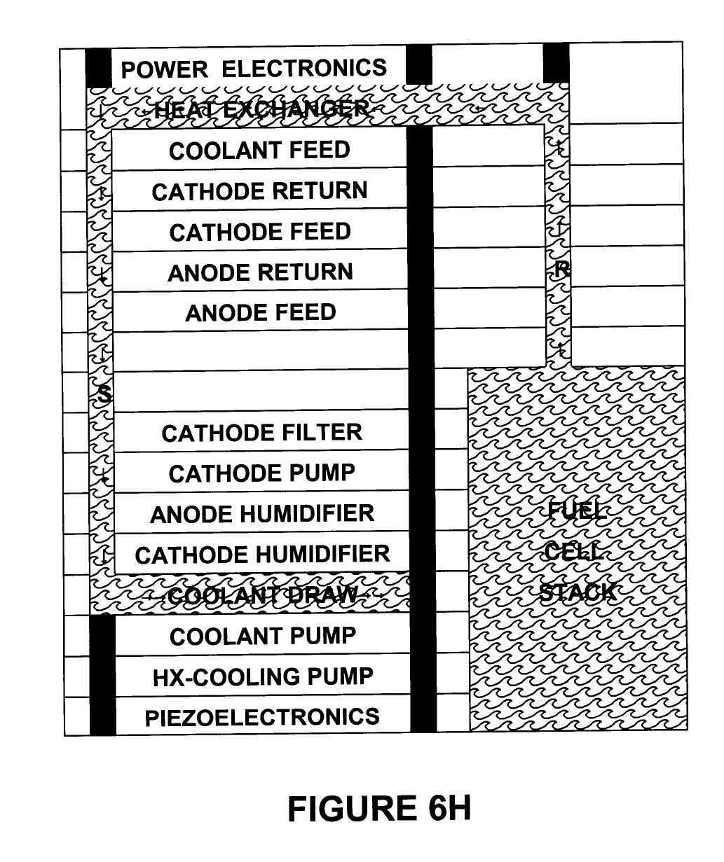

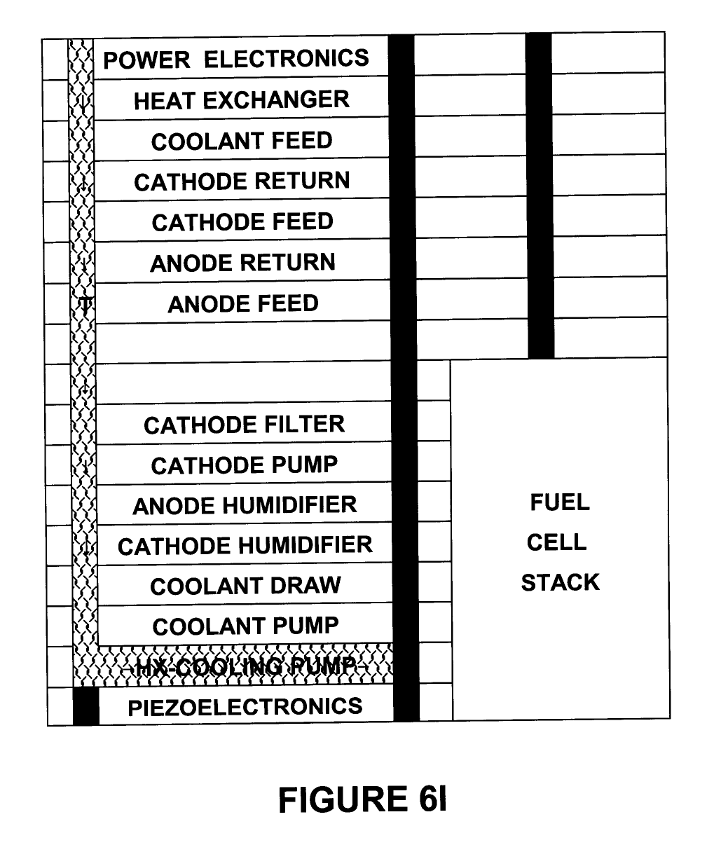

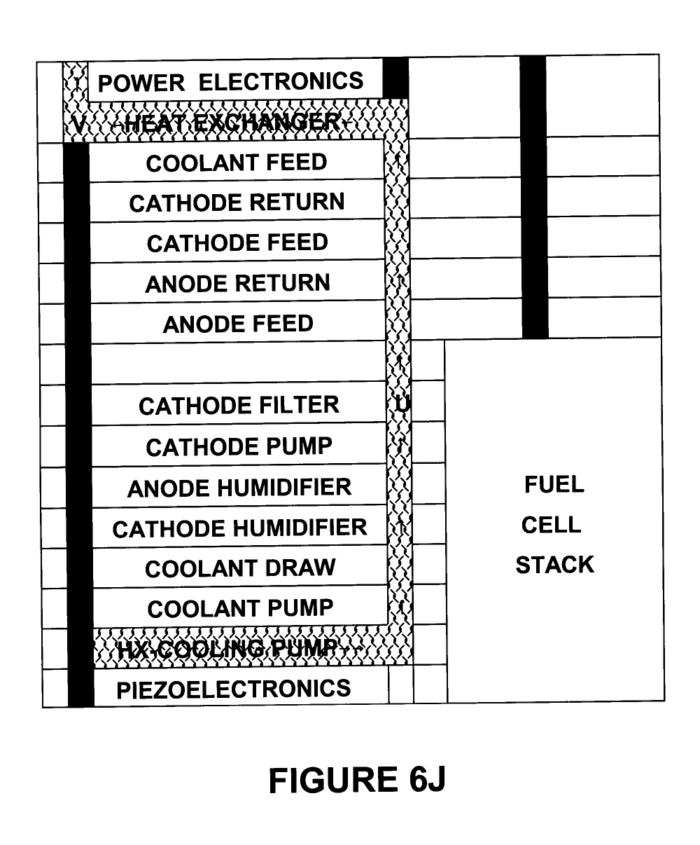

The layer assembly includes a cathode filter layer, a cathode pump layer, an anode humidifier layer, a cathode humidifier layer, a coolant draw layer, a coolant pump layer, a heat-exchanger-cooling fluid layer, and a piezoelectronics layer. The manifold includes an anode feed level, an anode return level, a cathode feed level, a cathode return level, a coolant feed level, a heat exchanger level, and a power electronics level. The anode fluid circuit (passageways A-F), the cathode fluid circuit (passageways G-N), the coolant fluid circuit (passageways O-S), and the heat-exchanger-cooling fluid circuit (passageways T-V) are shown in FIGS. 6A-6B, FIGS. 6C-6F, FIGS. 6G-6H, and FIGS. 6I-6J, respectively.

One may now appreciate that the layer assembly allows the assimilation of balance-of-plants features into the fuel cell system without complicated tubing, hosing, piping, or other plumbing. Also, the assembly can be constructed from a series of layers which each has the same starting structure, namely a planar configuration (i.e., planar opposite surfaces and a relatively small thickness) with rows of openings formed therein, whereby many different layer designs can be fabricated from a common master layer. Additionally or alternatively, pre-fabricated layers can be selected and arranged in a different orders to produce the desired fluid circuitry.

Although the fuel cell system, the fuel cell stack, the layer assembly, the layers, the fluid circuits, the flow paths, the openings, the manifold, and/or the manifold levels have been shown and described with respect to a certain embodiment or embodiments, it is obvious that equivalent alterations and modifications will occur to others skilled in the art upon the reading and understanding of this specification and the annexed drawings. In regard to the various functions performed by the above described elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature of the invention may have been described above with respect to only one or more of several illustrated embodiments, such feature may be combined with one or more other features of the other embodiments, as may be desired and advantageous for any given or particular application.

1. A fuel cell system comprising a fuel cell stack and a layer assembly providing fluid circuitry for the fuel cell stack;
wherein:
the layer assembly comprises a plurality of layers assembled in face-to-face contact and joined together in a fluid-tight manner;
at least some of the layers integrate fluid-interacting devices and/or fluid-conveying channels;
each of the layers has aligned openings forming potential passageways; and
the potential passageways are partially opened and/or partially blocked to form the fluid circuitry.

2. A fuel cell system as set forth in claim 1, wherein the fluid circuitry comprises an anode fluid circuit forming a flow path for anode gas through the fuel cell stack and a cathode fluid circuit forming a flow path for cathode gas through the fuel cell stack.

3. A fuel cell system as set forth in claim 2, wherein the anode fluid circuit comprises a humidifier through which the anode fluid circuit passes upstream and/or downstream of the fuel cell stack, and wherein the cathode fluid circuit comprises a humidifier through which cathode gas passes upstream and/or downstream of the fuel cell stack.

4. A fuel cell system as set forth in claim 2, wherein the cathode fluid circuit comprises a pumping device for delivering the cathode gas to the fuel cell stack.

5. A fuel cell system as set forth in claim 4, wherein the cathode fluid circuit comprises a filter and wherein the filter is positioned upstream of the pumping device.

6. A fuel cell system as set forth in claim 2, wherein the fluid circuitry includes a coolant fluid circuit forming a flow path for coolant fluid through the fuel cell stack.

7. A fuel cell system as set forth in claim 6, wherein the coolant fluid circuit includes a pumping device.

8. A fuel cell system as set forth in claim 7, wherein the coolant fluid circuit comprises a heat exchanger.

9. A fuel cell system as set forth in claim 8, wherein the fluid circuitry further comprises a heat-exchanger-cooling fluid circuit forming a flow path for a cooling fluid through the heat exchanger.

10. A fuel cell system as set forth in claim 1, wherein layers are aligned with the fuel cell stack.

11. A fuel cell system as set forth in claim 10, wherein the layers forming an anode fluid circuit and a cathode fluid circuit are situated on one non-lateral side of the fuel cell stack and layers forming other fluid circuits are situated on the opposite non-lateral side of the fuel cell stack.

12. A fuel cell system as set forth in claim 1, further comprising a manifold interfacing with the layer assembly.

13. A fuel cell system as set forth in claim 12, wherein the layers of the layer assembly are situated on one lateral side of the fuel cell stack.

14. A fuel cell system as set forth in claim 13, wherein the manifold is situated on one non-lateral side of the fuel cell stack.

15. A fuel cell system as set forth in claim 14, wherein the manifold comprises:
anode feed level and an anode return level which form part of an anode fluid circuit, and a cathode feed level, and a cathode return level which form part of the cathode fluid circuit.

16. A fuel cell system as set forth in claim 15, wherein the manifold includes a coolant feed level which forms part of the coolant fluid circuit.

17. A fuel cell system as set forth in claim 12, wherein the manifold incorporates a heat exchanger.

18. A fuel cell system as set forth in claim 1, wherein the plurality of layers includes at least one layer incorporating piezoelectronics.

19. A fuel cell system as set forth in claim 1, wherein the fluid-interacting devices comprise valves and/or pressure regulators.
